(19) United States
(12) Patent Application Publication
(10) Pub. No.: US 2015/0106395 A1
(43) Pub. Date: Apr. 16, 2015

(54) DYNAMIC CONTENT DELIVERY BASED ON METADATA-SEEKING BEHAVIOR

(71) Applicants: John Ellis STAFIRA, Dallas, TX (US); Jeffrey Bob BERTHIAUME, JR., Dallas, TX (US); Jeremy William CROTTS, Phoenix, AZ (US)

(72) Inventors: John Ellis STAFIRA, Dallas, TX (US); Jeffrey Bob BERTHIAUME, JR., Dallas, TX (US); Jeremy William CROTTS, Phoenix, AZ (US)

(21) Appl. No.: 14/513,717

(22) Filed: Oct. 14, 2014

Related U.S. Application Data
(60) Provisional application No. 61/891,051, filed on Oct. 15, 2013.

(51) Int. Cl. G06F 17/30; G06Q 30/02

(52) U.S. Cl. CPC G06F 17/30386; G06F 17/30887; G06Q 30/0251
USPC 707/758

(57) ABSTRACT

A media processing system provides services for metadata-seeking behavior. The system includes a memory that stores executable instructions and a processor that executes the executable instructions. The system also includes a receiver that receives, based on a person initiating capture of source input in seeking metadata for an object associated with the source input, source input from a requesting device used by the person to initiate the capture of the source input in the metadata-seeking behavior. Ultimately, content is dynamically identified for presentation to the person.

### CROSS-REFERENCE TO RELATED APPLICATIONS

This application claims the benefit of U.S. Provisional Patent Application No. 61/891,051, filed on Oct. 15, 2013, the disclosure of which is expressly incorporated herein by reference in its entirety.

### BACKGROUND

1. Field of the Disclosure

The present disclosure relates to the field of content delivery. More particularly, the present disclosure relates to delivering content dynamically based on metadata-seeking behavior that reflects interests of the seeker.

2. Background Information

One-dimensional bar codes and two-dimensional quick response (QR) codes have been developed to provide information by markings. Quick response codes can even be used to convey identifiable text, such as uniform resource locator (URL) codes, and devices may have applications that automatically launch browsers when uniform resource locator codes are recognized in images of quick response codes captured by cameras on the devices. The activity of capturing and analyzing images of one-dimensional bar codes, two-dimensional quick response codes and the like is generally known as “scanning”.

Radio frequency identification (RFID) systems use small transmitters to electronically emit data similar to data provided by one-dimensional bar codes and two-dimensional quick response codes. Radio frequency identification readers are devices that note the presence of a radio frequency identification signal. The repeated capture of a particular radio frequency identification signal can be used to show the movement of a transmitter over time. Radio frequency identification readers are operated such that their presence and movement through an area with radio frequency identification transmitters results in the detection of transmitted radio frequency identification signals. Therefore, capture of radio frequency identification signals does not require affirmative actions such as the scanning required for each one-dimensional bar code, two-dimensional quick response code and the like. Nevertheless, the affirmative actions required to capture bar codes and quick response codes, as well as the passive actions required to capture radio frequency identification data, are both properly characterized as metadata-seeking activity.

In addition to the above, information on people is collected by many entities including government agencies and companies that wish to target advertisements or support such government agencies and companies. Many internet users now recognize that advertisements they encounter seem to be directed specifically to them based on their behavior on the internet.

### BRIEF DESCRIPTION OF THE DRAWINGS

FIG. 1 shows an exemplary general computer system that includes a set of instructions for dynamic content delivery based on metadata-seeking behavior;

FIG. 2 shows an exemplary method for dynamic content delivery based on metadata-seeking behavior, according to an aspect of the present disclosure;

FIG. 3 shows another exemplary method for dynamic content delivery based on metadata-seeking behavior, according to an aspect of the present disclosure;

FIG. 4 shows another exemplary method for dynamic content delivery based on metadata-seeking behavior, according to an aspect of the present disclosure;

FIG. 5 shows an exemplary network for dynamic content delivery based on metadata-seeking behavior, according to an aspect of the present disclosure;

FIG. 6 shows another exemplary network for dynamic content delivery based on metadata-seeking behavior, according to an aspect of the present disclosure;

FIG. 7 shows another exemplary network for dynamic content delivery based on metadata-seeking behavior, according to an aspect of the present disclosure;

FIG. 8 shows another exemplary network for dynamic content delivery based on metadata-seeking behavior, according to an aspect of the present disclosure;

FIG. 9 shows another exemplary network for dynamic content delivery based on metadata-seeking behavior, according to an aspect of the present disclosure;

FIG. 10 shows another exemplary network for dynamic content delivery based on metadata-seeking behavior, according to an aspect of the present disclosure;

FIG. 11 shows another exemplary network for dynamic content delivery based on metadata-seeking behavior, according to an aspect of the present disclosure;

FIG. 12 shows another exemplary network for dynamic content delivery based on metadata-seeking behavior, according to an aspect of the present disclosure;

FIG. 13 shows another exemplary network for dynamic content delivery based on metadata-seeking behavior, according to an aspect of the present disclosure;

FIG. 14 shows another exemplary network for dynamic content delivery based on metadata-seeking behavior, according to an aspect of the present disclosure, and

FIG. 15 shows another exemplary network for dynamic content delivery based on metadata-seeking behavior, according to an aspect of the present disclosure.

### DETAILED DESCRIPTION

The term “metadata” as used herein mainly refers inclusively to descriptive data which describes substantive and meaningful content correlated to a captured data structure. The substantive content can be retrieved using the captured data structure.

Examples of metadata provided herein are the metadata identified using correlated 1-dimensional bar codes, 2-dimensional quick response codes, qyoos, radio frequency identification signals, near-field-communication (NFC) signals, Microsoft® tags, iBeacons and more generally Bluetooth Low Energy (BLE) triggers, EZ codes, and Image Processing (Computer Vision) The term “metadata” as used herein may also sometimes refer inclusively to structural data such as the language and protocol of a data structure by which the metadata is provided.

The behavior described mainly herein is active and passive behavior by users affirmatively seeking metadata. The behavior could be actively scanning a bar code or quick response code, capturing an image of a qyoo or other symbolic means that can be correlated with substantive and meaningful content, placing an active radio frequency information receiver in the vicinity of one or more radio frequency information transmitters, or placing a near field communication transceiver in the vicinity of another near field communication transceiver. These and other forms of activity that can be interpreted as showing an intent to seek metadata are used in coordinated manners described herein to provide users with information that is intended to be the most helpful and relevant possible. Such information can include advertisements, directions, discounted offers (i.e., “deals”), advice, suggestions or other information that may be found helpful by the users.

That is, metadata-seeking behavior is activity that directly involves capturing a source input either by scanning, capturing an image, receiving a signal, or otherwise obtaining the source input. The “intent” in the metadata-seeking behavior is the immediate intent of the user to capture the source input so as to obtain metadata descriptive of an object associated with the source input. Thus, metadata-seeking behavior may be active, such as in affirmatively pressing a button so as to scan or capture an image, or may be passive such as by carrying a receiver into the range of emitted wireless signals. Described herein are many forms of the “source input”, “objects” associated with the source input, and “metadata”.

As would be understood, the metadata-seeking behavior is typically expected to result in the return of metadata that describes an associated object. As described thoroughly herein, however, additional metadata can be used to provide additional content, including a variety of content that is not necessarily expected or sought by the person engaging in the metadata-seeking behavior. The additional metadata can be metadata descriptive of the person, the device used by the person, metadata provided by a network carrier, a social network, a third-party and so on.

In view of the foregoing, the present disclosure, through one or more of its various aspects, embodiments and/or specific features or sub-components, is thus intended to bring out one or more of the advantages as specifically noted below.

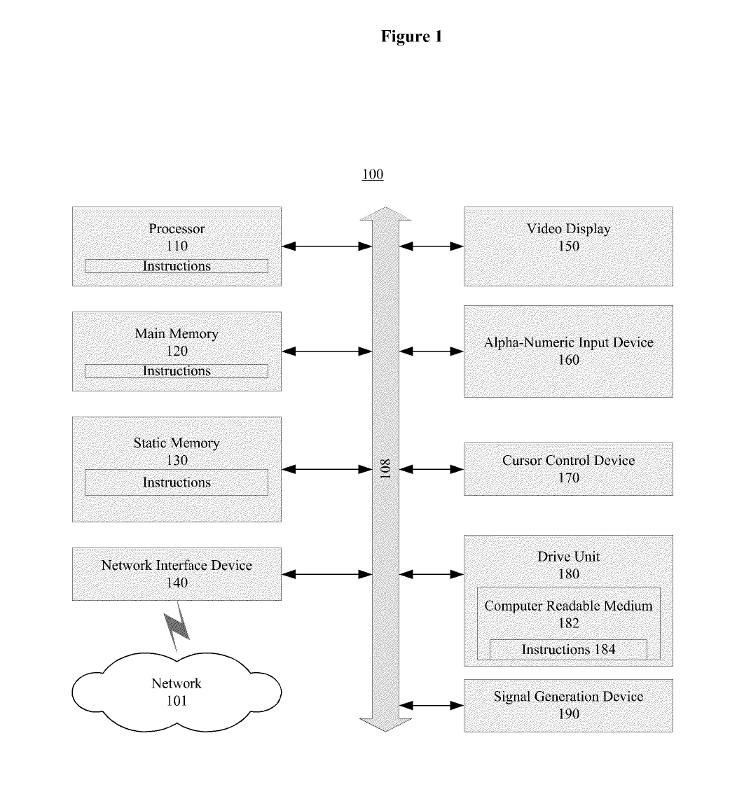

FIG. 1 is an illustrative embodiment of a general computer system, on which a method of dynamic content delivery based on metadata-seeking behavior can be implemented, and which is shown and is designated 100. The computer system 100 can include a set of instructions that can be executed to cause the computer system 100 to perform any one or more of the methods or computer based functions disclosed herein. The computer system 100 may operate as a standalone device or may be connected, for example, using a network 101, to other computer systems or peripheral devices.

In a networked deployment, the computer system may operate in the capacity of a server or as a client user computer in a server-client user network environment, or as a peer computer system in a peer-to-peer (or distributed) network environment. The computer system 100 can also be implemented as or incorporated into various devices, such as a wireless smart phone or other personal communication/wearable devices, an internet server, a communication server, or any other machine capable of executing a set of instructions (sequential or otherwise) that specify actions to be taken by that machine. The computer system 100 can be incorporated as or in a particular device that in turn is in an integrated system that includes additional devices. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 may include a processor 110, for example, a central processing unit (CPU), a graphics processing unit (GPU), or both. Moreover, the computer system 100 can include a main memory 120 and a static memory 130 that can communicate with each other via a bus 108. As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an input device 160, such as a keyboard/virtual keyboard or touch-sensitive input screen, and a cursor control device 170, such as a mouse or touch-sensitive input screen or pad. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g. software, can be embedded. A computer-readable medium 182 is a tangible article of manufacture, from which sets of instructions 184 can be read. Further, the instructions 184 may embody one or more of the methods or logic as described herein. In a particular embodiment, the instructions 124 may reside completely, or at least partially, within the main memory 120, the static memory 130, and/or within the processor 110 during execution by the computer system 100. The main memory 120, the static memory 130, and the processor 110 also may be or may include computer-readable media that are tangible and non-transitory during the time instructions 184 are stored therein. As used herein, the term “non-transitory” is meant only to be interpreted by one of ordinary skill in the art with common sense, and not as an eternal characteristic of something that would last beyond the universe. The term “non-transitory” specifically disavows fleeting characteristics such as characteristics of a particular carrier wave or signal or other forms that exist only briefly in any place.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations. Nothing in the present application should be interpreted as being implemented or implementable solely with software and not hardware such as a tangible processor and tangible memory.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 182 that includes instructions 184 or receives and executes instructions 184 responsive to a propagated signal; so that a device connected to a network 101 can communicate voice, video or data over the network 101. Further, the instructions 184 may be transmitted or received over the network 101 via the network interface device 140. The computer-readable medium 182 or any other computer-readable medium contemplated herein may be a tangible machine or article of manufacture that is tangible and non-transitory for a period of time during which instructions and/or data are stored therein or thereon.

As described herein, an object is associated with a source that can be captured and input to a mobile device including, e.g., a smartphone, google glasses, smartwatch/apple watch. Metadata can be used to describe the object associated with the source input, the person, the device etc. The object may be consumer goods packaging, out of home advertising such as posters and billboards, mailers, buildings, store locations, and any 3 dimensional real world object such as a car, a statue, or a chair. In this way, a source associated with the object can be input to the mobile device. The source may be a Qyoo, barcode, or other capturable source of input that is directly, immediately and/or particularly associated with the object.

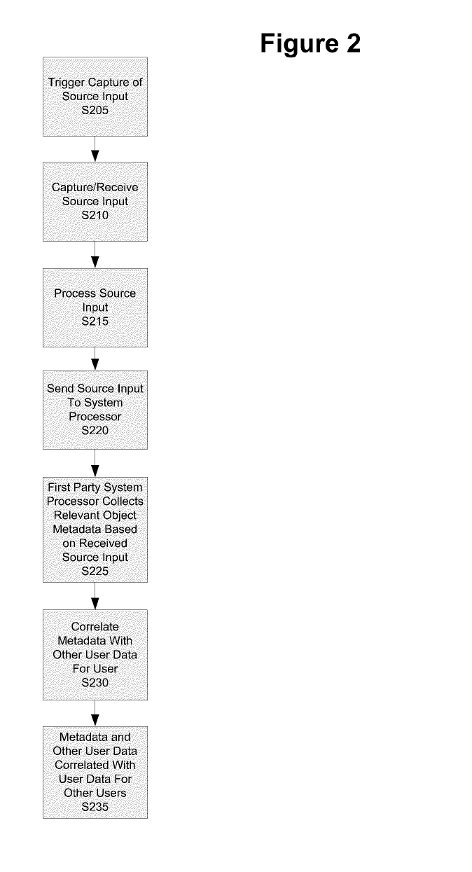

FIG. 2 shows an exemplary method for dynamic content delivery based on metadata-seeking behavior, according to an aspect of the present disclosure. In FIG. 2, the process starts with a trigger to capture source input. The trigger may be a user activating an application on a user device to capture an image of a bar code, quick response code, or qyoo. The trigger may also be placing a user device with near field communication capabilities in the vicinity of another apparatus with near field communication capabilities. The trigger may also be bringing a radio frequency identification receiver into the vicinity of radio frequency identification signals. These and other similar actions are metadata-seeking behavior. At S210, the source input is captured or otherwise received, and at S215 the source input is processed. That is, an image processor may process an image to isolate a bar code, quick response code, or qyoo, and then identify the unique meaning of the identified source input. Similarly, a processor may process a received radio frequency identification signal, near field communication signal, or similar form of input. Therefore, in these examples the source input itself is the bar code, quick response code, qyoo, radio frequency identification signal, or near field communication signal.

The source input and/or the processing result of the source input is sent to a system processor over a network at S220. This sending at S220 may be from a smartphone across a wireless data network ultimately to an application server that uses the source input and/or processing result to collect relevant metadata. The first party system processor receives the source input and collects relevant object metadata and other metadata based on the received source input at S225. The object metadata is descriptive of the object associated with the source input. Other forms of collected metadata can also include metadata descriptive of the person initiating the capture of the source input, metadata descriptive of the device used to capture the source input, metadata of the date and time and place of the source input. For example, additional collected object metadata could be location, sponsor, content, meaning or other information descriptive of the source input and/or processing result of the source input. At S230, the collected metadata is correlated with other historical user data descriptive of the history of the user, and at S235, the metadata and other user data are correlated with user data for other users.

The processes at S230 and S235 may be complex processes to identify the most relevant information to return to the user of the requesting device. The identification of content can be based on successful experiences of others who have sought metadata from the same or similar sources. The processes may involve first identifying previous user history for the same user at S230, such as shopping history, or visit history to locations similar to the location of the immediate source that conveys the source input. As an example, if an image results in a determination that a source is at or near to a coffee shop, the first party system processor may recognize at S230 that the user frequently captures source input at or near coffee shops, and may indeed appreciate a quick discounted offer for coffee at a nearby coffee shop. As another example, if an image results in a determination that a source is at or near to a coffee shop, the first party system processor may recognize at S230 from spending data for the user that the user frequently makes purchases at coffee shops, and may appreciate a quick discounted offer for a discounted purchase at a nearby coffee shop. These determinations can also be based on comparisons with histories of other users with similar characteristics.

As another example, at S235 the metadata and other user data may be correlated with user data for other users to identify the most relevant content to present to the user. At S235, this exercise may be to select content from many choices, by seeing which content was most effective in receiving a response from users of similar gender, age, spending patterns, locations, capture histories, income levels, or similar available information. In this manner, a user capturing source input at, for example, an entrance to a mall may result in a personalized set of offers that are particularly relevant to the user. The personalized set may be identified from characteristics set forth by the offer providers, such as income levels and gender and age. The personalized set may also be identified from characteristics of offers accepted by similar users who captured the same source input.

As described herein, historical data descriptive of a history of a person initiating the capture of source input can include a variety of information descriptive of past activity of the person. Such historical data can include objects such as clothing, furniture and electronics related to previous purchases, upgrades in video games related to previous game play, “likes” or expressions of interests on an online social network, stored recipes, sports interests, downloaded books, rewards/loyalty data, mobile payment data, photo interests, bookmarked webpages, movies previously watched, music data reflective of musical tastes, location check-ins, and reservations.

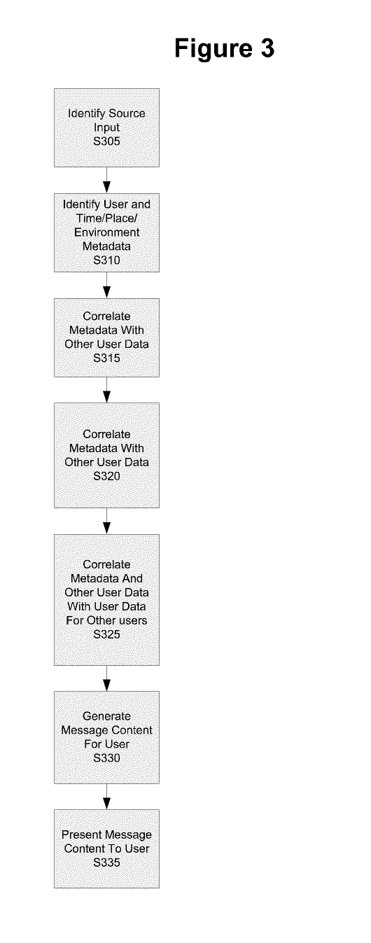

FIG. 3 shows another exemplary method for dynamic content delivery based on metadata-seeking behavior, according to an aspect of the present disclosure. Before describing the process of FIG. 3, it should be made clear that message content presented to a user can be presented in many ways, including via text, email or banner ad on the requesting user device, or in a printout from a kiosk or register or on a receipt, or on an image or video screen near to the location of the user. Message content can also be delivered audibly by a sound system, or even by another human who receives instructions to contact the person who just captured a source of source input. That is, message content can be delivered in many ways at S335 described below, and the means of delivery are not limited to a particular messaging form or communications mode or medium.

In FIG. 3, source input is identified at S305. At S310, the user and source metadata for source input is identified, so as to identify the time source input is received, the location of the source of the source input, and immediately known information associated with the source input, such as information pre-correlated to a unique value of the source input including a business name, location name and other aspects that might logically be correlated with a particular source of source input at a particular site. At S315, the identified metadata is correlated with other user data that is independent of the original source input, such as user gender, age, historical information, income level etc. At S325, the metadata and other user data are correlated with user data for other users. At S330 message content is generated particular for the user and tailored for the circumstances in which the source input was captured. At S335, message content is presented to the user.

Although the source input is mainly described herein as having a unique value or meaning, the source input may also be recognizable as having a meaning that applies to multiple items such as a class of items. For example, an image of a chair might be taken by a user device and then sent back to a first-party system as described herein. The chair might be recognizable generically as a chair, or even as a particular brand or model of a chair. Chairs may be generally pre-correlated with metadata that describes any chairs, such that once recognized the metadata is correlated to the specific image and request from the user. In this way, multiple images of different chairs may result in correlations with the same metadata in appropriate circumstances using the present disclosure.

In relation to the chair example, metadata is correlated with other data. The correlated “other data” is used to customize and even personalize content sent to the user. As a result, two users can take a picture of the same chair, and the identification of the “other data” can be then used to return customized content to the users such that the content differs for two users taking the same picture of the same chair. For example, a user A may have an online history of looking up architects. User A gets a result page that talks about the architect who designed the chair. User B may have an online history of looking at fabric patterns. User B gets a result page that has all the different fabrics the chair is available in.

Additionally, correlations from source input are generally described as pre-correlations herein. However, correlations between source input and metadata may be dynamically generated using the disclosure herein, such as when unrecognized source input is first sent to a system and the system recognizes that the source input is not pre-correlated. Accordingly, the system may dynamically attempt to recognize the source input and assign metadata in accordance with the efforts to recognize the source input. The metadata may include information determinable from the user device and/or a network provider, such as location, application used to obtain the source input, user capturing the source input, and so on. Therefore, the source input described herein may be pre-correlated, or dynamically correlatable.

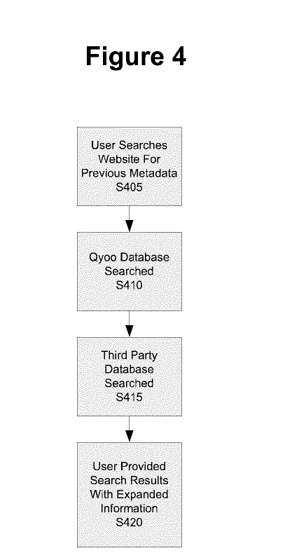

FIG. 4 shows another exemplary method for dynamic content delivery based on metadata-seeking behavior, according to an aspect of the present disclosure. At S405, a user may search a website for previous metadata presented based on previous captures of source input. In this way, a user may locate information to expand on the metadata already provided. At S410, a first party (source input provider or affiliate) database is searched for additional information that may explain context to the user for the captured source input, and at S415 a third party database is searched for additional information that may explain context to the user for the captured source input. At S420, the user is provided search results with the expanded information from the first party database and third party database. In the process of FIG. 4, a user directly receives benefits of the full range of information used to provide message content selectively in FIG. 3. In this way, in FIG. 4 a user may be able to see expanded information of what other users found useful in relation to their previous capture of source input, such as a number of or demographic information of other users who made a particular purchase after previously capturing particular source input. That is, in FIG. 4 a user may learn how other users benefit from message content presented after capturing particular source input, so that the user can obtain the same benefit in the future. Similarly, in FIG. 4 a user may be provided with an expanded data set beyond the message content provided in FIG. 3, such as the full set or at least a more complete set of options from which the message content in FIG. 3 was selected.

Results may be provided to a user as a results page, either of one or more pieces of fixed content such as banner ads, or as a page that includes interactive content such as selectable links. A results page may include one or more tailored and personalized advertisements, such as when a user captures a source of source input when entering a mall. Of course, results also may be provided as less than a full screen or page, such as when a result is provided only as a window at the top of a screen on a user device and the remainder of the screen is used to show the user what the user was already viewing prior to capturing the source input.

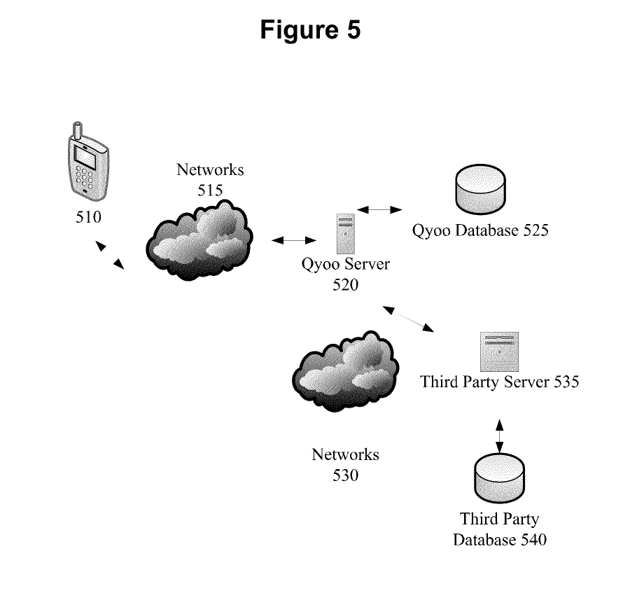

FIG. 5 shows an exemplary network for dynamic content delivery based on metadata-seeking behavior, according to an aspect of the present disclosure. In FIG. 5, a requesting user device 510 is used to capture source input and send the source input or an analysis result of the source input across networks 515. First party (Qyoo) server 520 analyzes the source input and correlates the source input with metadata in a first party (Qyoo) database 525. The Qyoo server 520 may also interact across networks 530 with a third party server 535 to correlate the source input and metadata with other data for the user and other data for other users in third party database 540.

In FIG. 5, the other user data in third party database 540 may be data such as social network profile information for the user, including likes, friends/contacts, listed profile information and similar information. The other user data in third party database 540 may also be data such as internet history data from a communications carrier, spending history from a credit card company, or other types of information collected by other third parties different from the sponsor of the source input that is initially captured. Any of the other data for the user, or other data for other users, can be used to dynamically identify and provide tailored/customized/personalized message content to the user of the requesting user device.

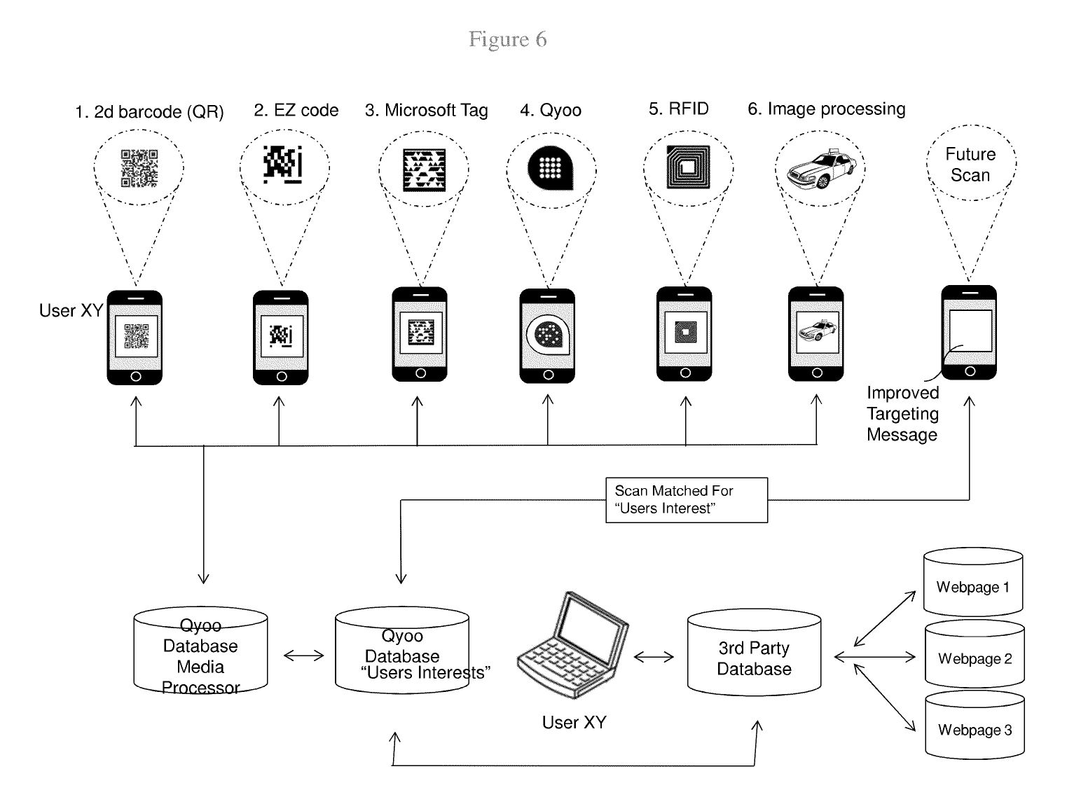

FIG. 6 shows another exemplary network for dynamic content delivery based on metadata-seeking behavior, according to an aspect of the present disclosure. In FIG. 6, a variety of different types of source input are captured by user XY on the different user devices shown in the Figure. The different types of source input captured include two dimensional barcodes/quick response codes, so-called EZ codes, Microsoft tags, qyoos, radio frequency identification data, and other image processing source input. The source input is processed and sent to the Qyoo (first party) system processor/database to identify metadata, then to correlate the metadata with other user data/user interests in the first party database, and then on to 3rd party databases for other data for the user, and other data for other users. These 3rd party databases may collect information from one or more websites that contain user information for the user, such as social networking websites, financial websites, credit card or other banking websites that track the user's spending, or other sources of data for the user or other users.

Source input is described herein mainly as captured images or captured wireless signals such as radio frequency identification tags. However, source input may also be captured audio data, such as inaudible acoustic signals detectable by a user device. Of course, audible or inaudible acoustic signals should not be in a wavelength range that would be found bothersome to humans (or pets). Acoustic signals could be captured as source input and then used to identify correlated or correlatable metadata as described herein. The acoustic signals could be captured by a microphone on a user device, and even translated into non-acoustic data with a unique or non-unique value as described herein.

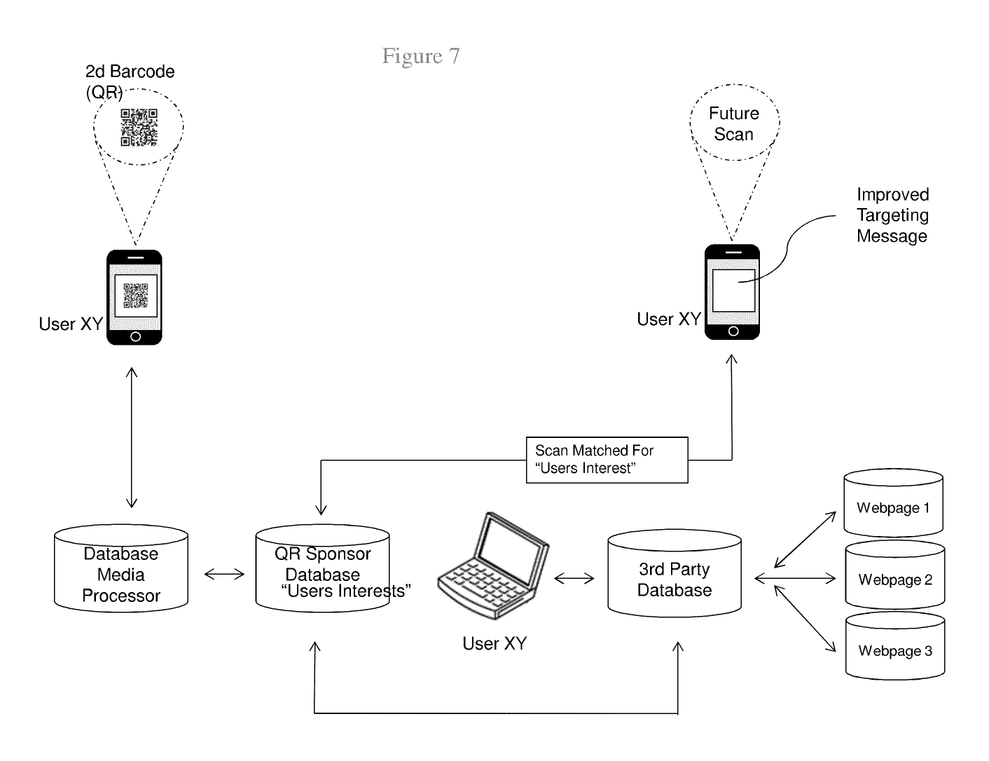

FIG. 7 shows another exemplary network for dynamic content delivery based on metadata-seeking behavior, according to an aspect of the present disclosure. In FIG. 7, a two dimensional quick response code is captured as source input by a user XY using a device, and the source input is analyzed and sent to database media processor for a sponsor of the quick response code. The sponsor (first party's) database is searched for the user history for the user, and then for other user histories for other users as previously described. The third party database is similarly used to correlate information for the user and for other users from other sources. Ultimately, the goal in FIG. 7 is to return tailored/customized/personalized message content to the user in a dynamic response to the capture of the original source input. In FIG. 7, the source input is quick response codes, and the first party database is a sponsor of a quick response code that is captured by a user.

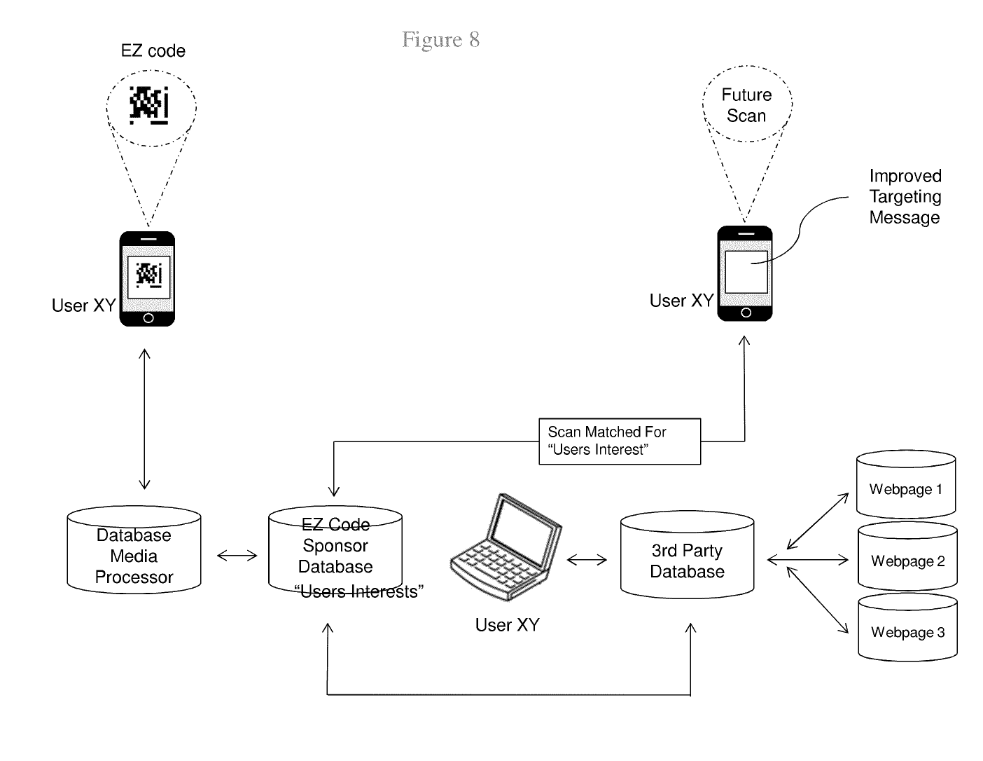

FIG. 8 shows another exemplary network for dynamic content delivery based on metadata-seeking behavior, according to an aspect of the present disclosure. In FIG. 8, the source input is an EZ code, and the first party database is a sponsor of an EZ code that is captured by a user.

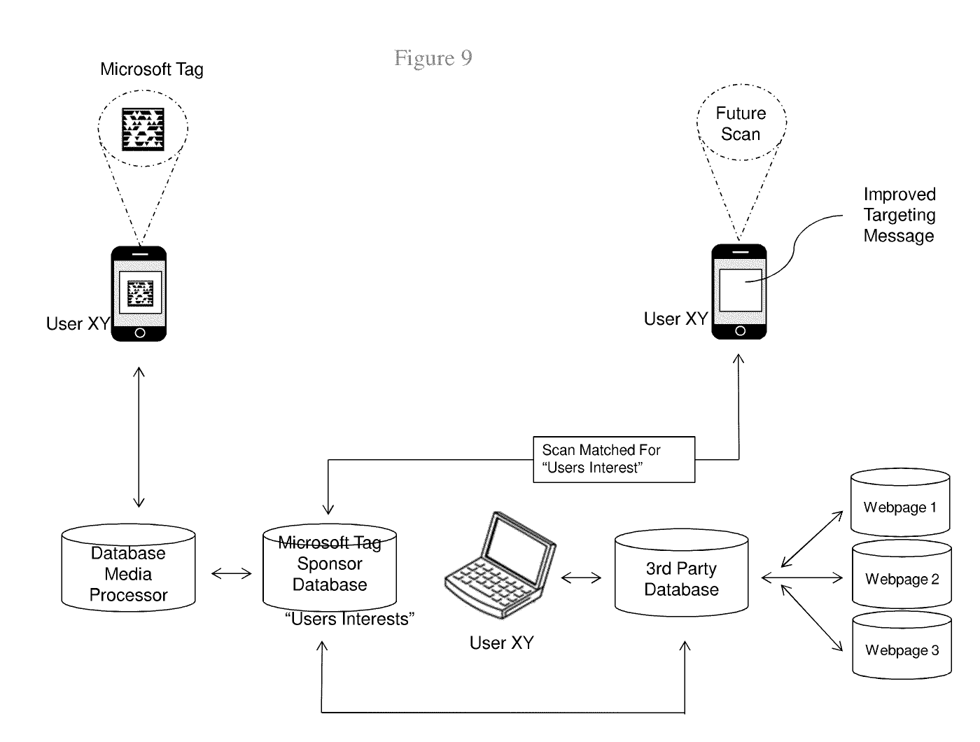

FIG. 9 shows another exemplary network for dynamic content delivery based on metadata-seeking behavior, according to an aspect of the present disclosure. In FIG. 9, the source input is a Microsoft Tag, and the first party database is a sponsor of a Microsoft Tag that is captured by a user.

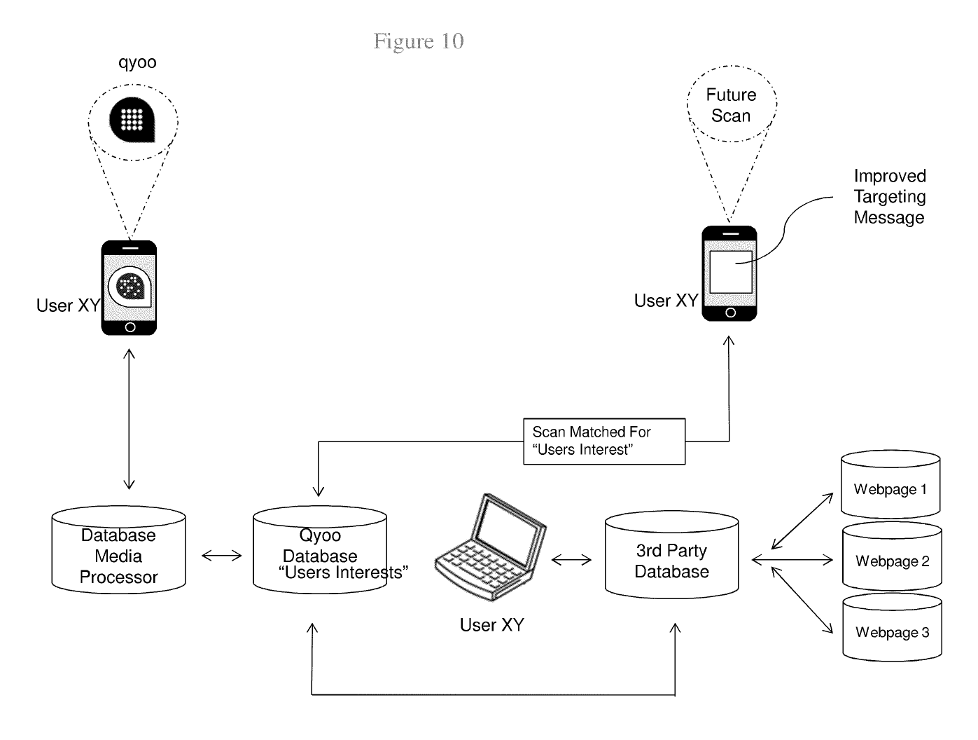

FIG. 10 shows another exemplary network for dynamic content delivery based on metadata-seeking behavior, according to an aspect of the present disclosure. In FIG. 10, the source input is a qyoo, and the first party database is a sponsor of a qyoo that is captured by a user. For the benefit of explanation, qyoos are described in U.S. patent application Ser. No. 12/964,987, the contents of which are expressly incorporated herein by reference in their entirety.

As described in the noted U.S. patent application that describes qyoos, a qyoo can be in any two colors, as long as those colors are high-contrast. A qyoo can be printed or displayed in any size, but is preferably printed no smaller than 0.75″ in width and height. A qyoo is a shape consisting of a circle with radius r, and a square having sides of lengths equal to r, positioned by default state in the lower right-hand corner of the circle. This describes the typical layout—however, the qyoo may be rotated and displayed in any two-dimensional angle. The upper left corner of the square in the qyoo intersects with the absolute center of the circle. The outline of a qyoo forms three fourths of a circle with radius r and one half of a square with sides of length r. The outline forms the equivalent shape that would be formed by aligning and overlaying a square with sides of length r as described above with one corner aligned with the center of the circle with radius r.

In use, an image pattern recognition program can analyze an image that includes all or most of the qyoo, and recognize the pattern of the qyoo. The orientation of the qyoo is determined by the relative placement of the square in the circle (the pointed edge), as the proper orientation of the qyoo is with the corner of the square outside the circle being the lower right-hand corner of the qyoo.

Qyoos and other source input are used to retrieve content across networks. User devices include cell phones, personal digital assistants, tablets and the like with both imaging capabilities (camera) and communications capabilities.

In the various embodiments described herein, user devices communicate with application servers through a data network. In normal operation for qyoos and quick response codes, the application servers retrieve metadata content from content repositories. In this way, user devices can each retrieve software applications, run software applications, and retrieve directly metadata content corresponding to the substantive data in a qyoo from a content repository via an application server. However, in the embodiments described herein, the metadata is correlated with other user data for the user including history data. In the embodiments described herein, the metadata and other user data may also be correlated with other user data for other users from the first party databases and third party databases.

An application on a user device may analyze an image captured by a user, recognize the source of the source input, and even adjust the image to read embedded source input properly. As an example, an image may be analyzed to identify source input which can be read as a uniform resource locator (URL) that can be executed on a web browser of a user device so as to visit a website. This source input can also be sent back to the first party qyoo database in FIG. 10, and then used to search for other data for the user and other user that can be sent as message content to the user. In this way, advertisements or other tailored content can be provided to the user based on the initial capture of the source input.

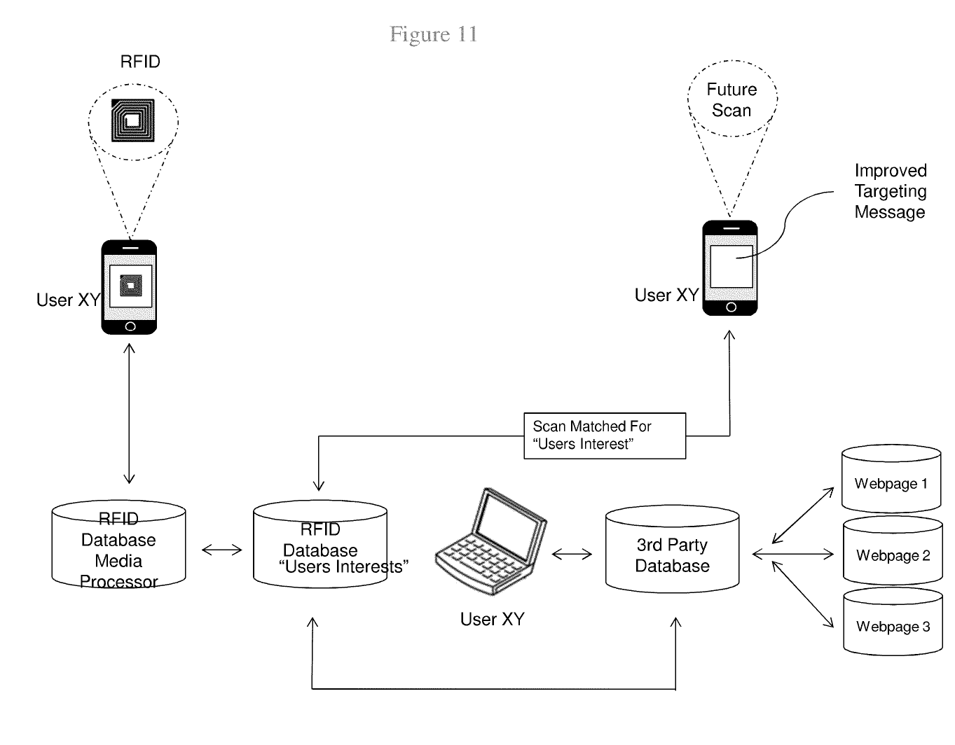

FIG. 11 shows another exemplary network for dynamic content delivery based on metadata-seeking behavior, according to an aspect of the present disclosure. In FIG. 11, the source input is radio frequency identification data, and the first party database is a sponsor of radio frequency identification information that is captured by a user.

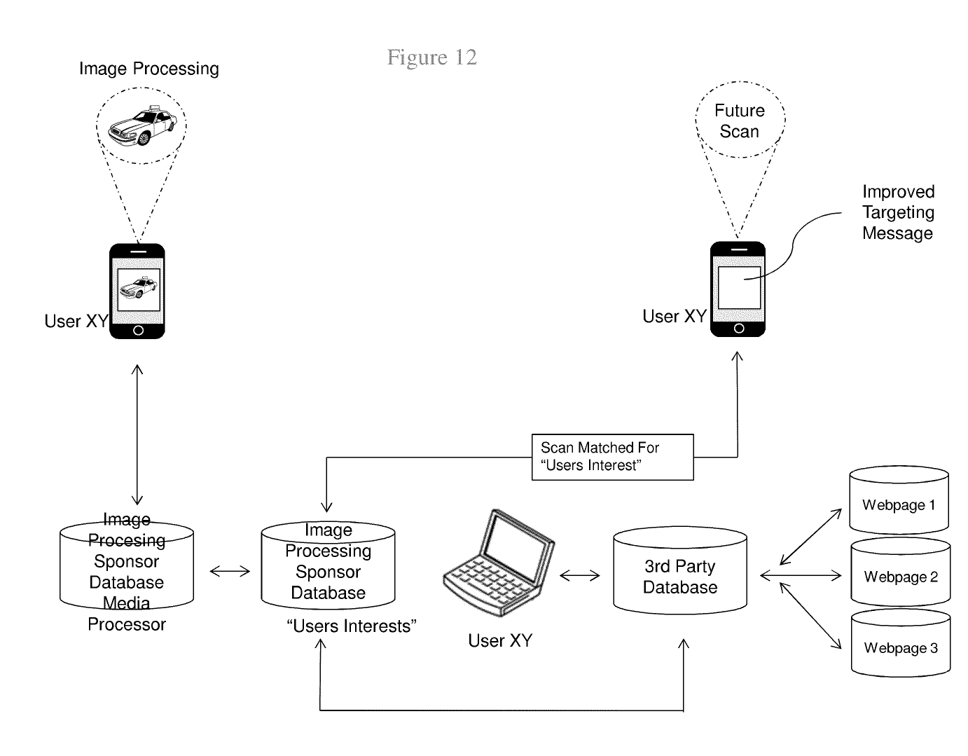

FIG. 12 shows another exemplary network for dynamic content delivery based on metadata-seeking behavior, according to an aspect of the present disclosure. In FIG. 12, the source input is an image, and the first party database is a sponsor of an image that is captured by a user.

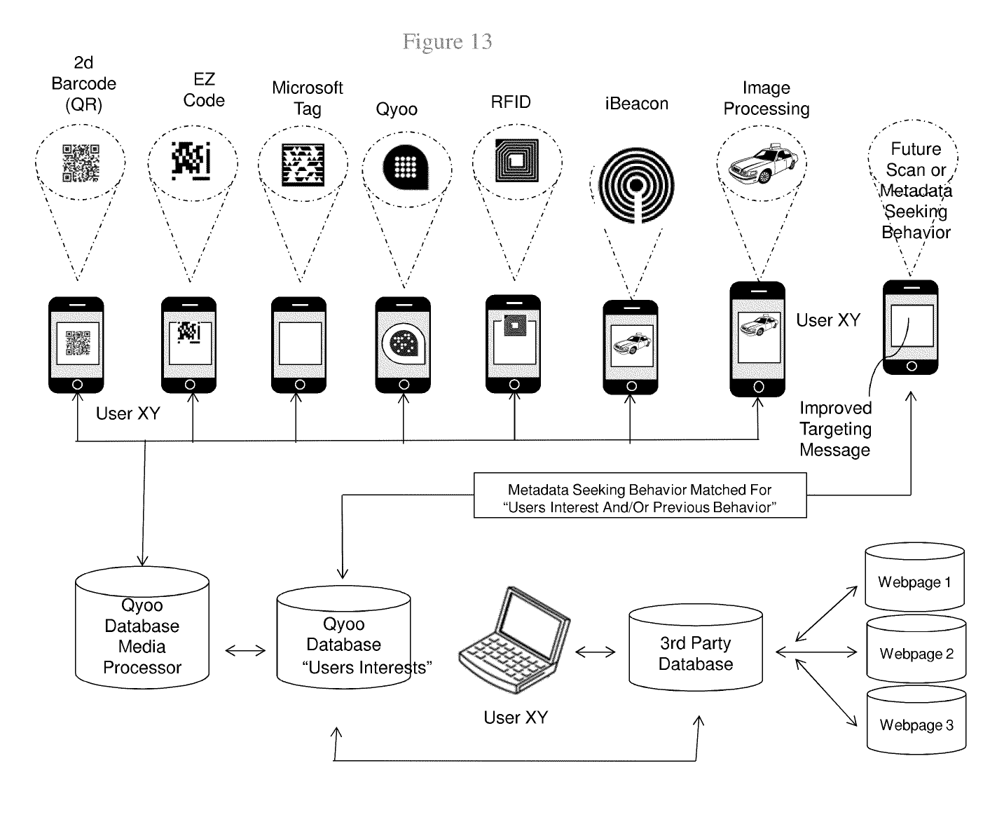

FIG. 13 shows another exemplary network for dynamic content delivery based on metadata-seeking behavior. Consistent with the explanations herein, n the embodiment shown in FIG. 13 types of collected metadata can be categorized as barcode-type metadata, near field communication (NFC) type metadata, and image identification-type metadata. Barcode-type metadata includes 2D barcode metadata, EZ code metadata, Microsoft tag metadata, and Qyoo metadata. Near field communication (NFC) type metadata include radiofrequency identification (RFID) metadata and iBeacon metadata. iBeacon is based on Bluetooth Low Energy (BLE) technology triggers, and is a low-powered transmission that can notify nearby mobile devices of presence in a manner similar to RFID. Image identification-type metadata includes image processing metadata.

In the embodiment of FIG. 13, metadata seeking behavior is matched for user interests and/or previous behavior when a user later engages in scanning or other metadata seeking behavior. The matching occurs based on data stored in the Qyoo database media processor, which in turn may have been obtained based on previous instances of scanning or other metadata seeking behavior involving any of the metadata collection types show in FIG. 13. The matching may also in turn have been obtained based on other information obtained about the user from a 3rd party database, including information obtained from visits to external webpages 1, 2 and 3 as shown.

In the embodiment of FIG. 13, iBeacon is shown as a metadata collection mechanism. iBeacon is also described above as belonging to a group of NFC-type metadata collection mechanisms. iBeacon uses a low-power transmitter to indicate presence to nearby devices. iBeacon enables push notifications to devices in close proximity. An exemplary use of iBeacon is to provide predetermined information relating to the location and context of the transmitter, such as to send fixed notifications of a nearby item and why a person might be interested in the nearby item.

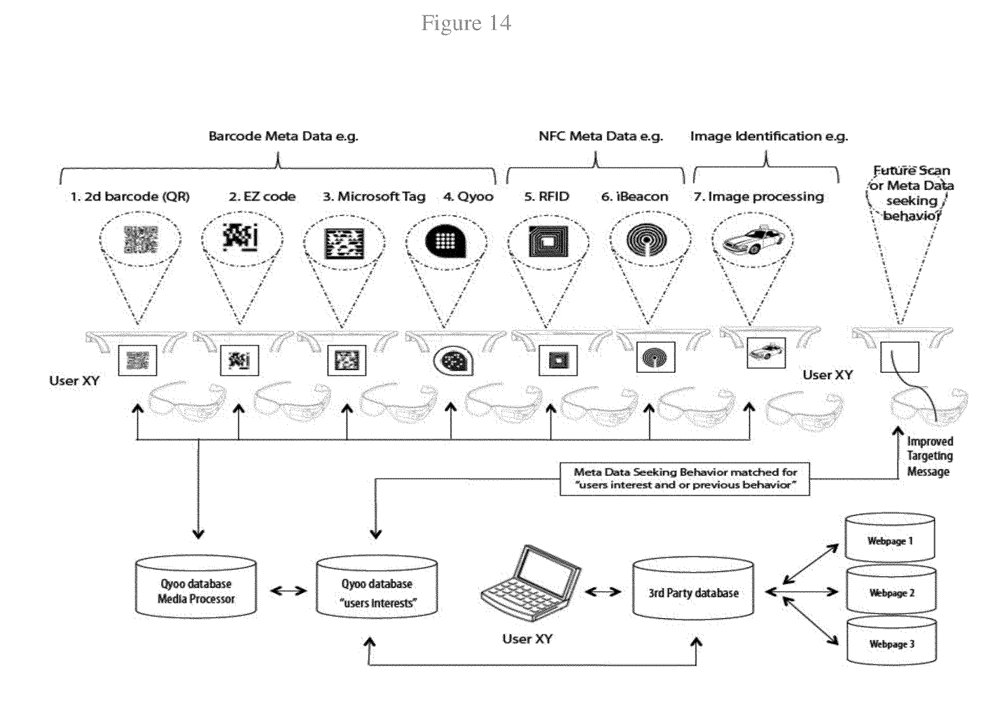

FIG. 14 shows another exemplary network for dynamic content delivery based on metadata-seeking behavior. In the embodiment of FIG. 14, each of the metadata collection mechanisms is used in conjunction with wearable electronic equipment, exemplified by wearable electronic eyeglasses. The receivers and scanners shown previously in association with smartphones and other general-purpose communications equipment are provided in association with the wearable electronic eyeglasses in FIG. 14. That is, wearable electronic eyeglasses can be used to capture and/or collect 2d barcodes, EZ codes, Microsoft Tags, Qyoos, RFID signals, iBeacon signals, and capturable images, as well as other types of similar metadata collection mechanisms developed in the future.

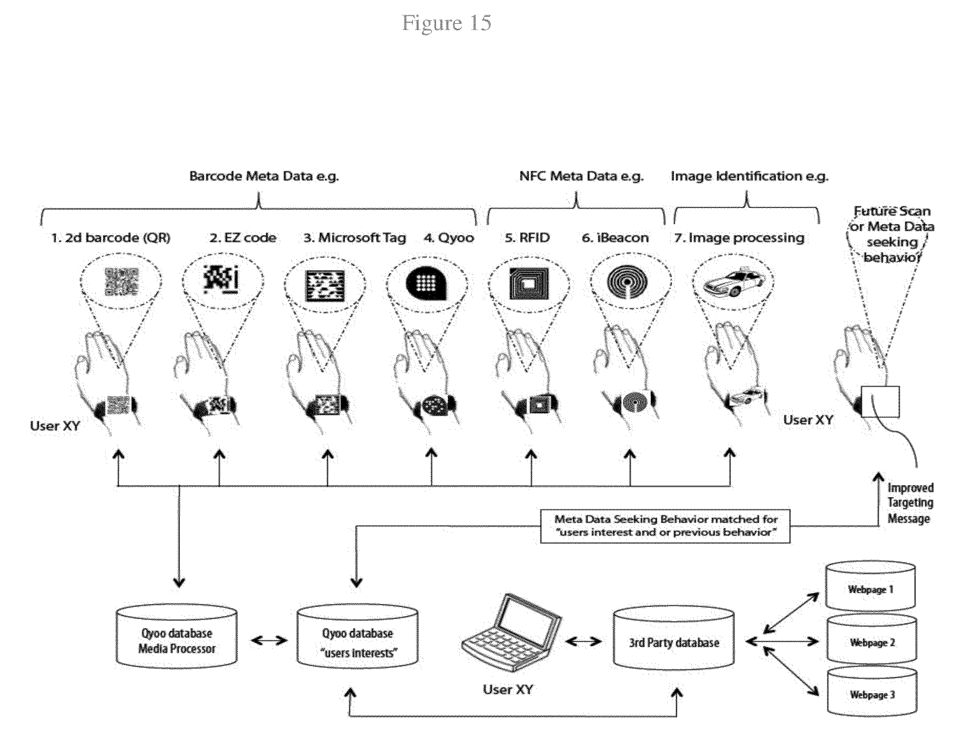

FIG. 15 shows another exemplary network for dynamic content delivery based on metadata-seeking behavior. In the embodiment of FIG. 14, each of the metadata collection mechanisms is used in conjunction with wearable electronic equipment, in this example a wearable electronic watch. The receivers and scanners shown previously in association with smartphones and other general-purpose communications equipment are provided in association with the wearable electronic watch in FIG. 14. That is, wearable electronic watches can be used to capture and/or collect 2d barcodes, EZ codes, Microsoft Tags, Qyoos, RFID signals, iBeacon signals, and capturable images, as well as other types of similar metadata collection mechanisms developed in the future.

Accordingly, the present invention enables an entity to provide relevant advertisements and other types of information to users not just based on their internet behavior or other known detectable behavior, but also based on specific information obtained from metadata-seeking behavior such as scanning, passive use of radio frequency identification devices, and the like. The metadata-seeking behavior is both tied to information such as user information, location, context and device to storage in databases, but is also used to identify existing database information that will assist in providing relevant advertisements and other forms of information to the user. Thus, information from the user-side identified at least in part based on the metadata-seeking behavior can be correlated with existing information to help identify advertisements and other forms of information to present to the user.

Although dynamic content delivery based on metadata-seeking behavior has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

In accordance with an aspect of the present disclosure, a media processing system identifies metadata from source input obtained based on metadata-seeking behavior. The media processing system includes a memory that stores executable instructions, a processor that executes the executable instructions, and a receiver that receives source input from a requesting device used to capture the source input in metadata-seeking behavior. When executed by the processor, the instructions cause the system to perform operations. The operations include identifying, from the source input, metadata that is uniquely correlated with the source input. The operations also include identifying, from the metadata identified, a historical data correlated with the metadata. The operations further include comparing the historical data to data in a database for correlations that will identify content to present to a user of the requesting device. The operations also include dynamically identifying content based on the comparing, and sending the content dynamically identified for presentation to a user of the requesting device.

In an example, the source input itself is the unique data provided by, e.g., a bar code, Qyoo, EZ code, Microsoft Tag, RFID, or uniquely identifiable image or other signal. The unique data may be a number, alpha-numeric combination, alphabetic combination, or other form of unique pattern. In turn, the metadata is the information that is pre-correlated with the source input. For example, metadata might be product and/or location information pre-correlated with the source input by the business or other entity that provides the source input. The metadata is therefore descriptive of the source in the sense that it describes what is intended by the provider for recipients to understand or know about the source.

In an example from the identified metadata which is pre-correlated with the source input, the historical data may be other forms of related information correlated with the metadata. The historical data is not uniquely correlated with the underlying source input however. Rather, the historical data may be background information that is dynamically correlated with the metadata including previously-identified metadata. In accordance with another aspect of the present disclosure, the historical data includes location history of the requesting device. In accordance with yet another aspect of the present disclosure, the historical data includes gender of the user of the requesting device. These and other forms of background information are not uniquely correlated with the source input, but are dynamically correlated with the metadata in order to associate the metadata with the circumstances in which the source input is captured.

In an example, data in a database is compared to the historical data in order to identify correlated content to present to a user of the requesting device. In this way, content of interest to users associated with similar characteristic background information (i.e., first sets of data) may be found of interest to the users with the historical data. Similarly, content of interest to the same user from previous acquisitions of source input, or known public histories such as social media, can be analyzed so as to identify content of interest to present to the user.

An example of how the source input could be used is for a real estate listing provider. A user of a social media internet application may register an indication of interest in a particular type of real estate, such as Country French Homes, using the social media internet application. This interest is publicly associated with the user by the general-purpose social media application. Later, the user scans an image of unique source input in a magazine article, where the unique source input is provided for an advertisement involving a particular home listed by the real estate listing provider, the real estate listing provider generally, or other information provided by the real estate listing provider. The metadata that is provided by the scanning application may describe the advertisement, including magazine name, issue date, page number, actual item shown for sale, or the information of the advertising company (i.e., the real estate listing provider). From this metadata and similar previously-identified metadata, a correlated set of information involving the user or device is obtained. This correlated set of information may include the user's original registration of an indication of interest in the particular type of real estate such as Country French Homes, which as originally indicated using the social media internet application. In this way, the historical data correlated with the metadata may be known information of the user that can be considered relevant to the metadata associated with the newly-acquired source input. Here the relevancy is that the user has captured source input for a real estate advertisement, and information from a completely separate application used by the user is known to reflect an interest in the particular type of real estate, i.e., Country French Homes. This then helps the provider of the real estate advertisement identify listings likely to be of interest to the user, and send these listings to the user. Of course, other metadata such as location information of the source input advertisement can be used to help narrow the particular listings that are provided to the user. Additionally, the historical data may include other similarly relevant data known about the user or user device, which is then also used to help identify the content likely to be of interest to the user. The database data may be, for example, listings in the area that match the interests previously registered by the user. Therefore, from the source input captured by the user, a complex process can be used to identify content to provide to the user.

Another example involves a user with an identifiable online history. For example, mechanisms are already known for identifying interests of users online, including pages viewed, ads clicked, interests “liked”, and so on. Additionally, a user's history of purchases may be known by at least the retailer from which the purchases are made. For an exemplary user, an online history may indicate an interest in the color red, such as from interest in a red dress and other red objects. An online or physical purchase history is then stored in one or more databases as the data in the database described herein. Later, the user may capture source input in an in-store advertisement or a print advertisement. The metadata associated with the particular source input can be identified from the known correlation. Then, the historical data correlated with the metadata can be identified. Here, the historical data may be the user device or user information, and the historical data is then compared to information in the database for the same or similar user device or user. From this, the previous interests in the color red and previous purchases can be identified. Based on this, the user can be provided with a communication or communications with product suggestions, such as red dresses or shoes, or with an offer of a discount for a product.

In another example, a user's online history and purchase history at a grocery store can be used to present content to the user such as grocery coupons. For example, a recipe assistant application on a user device may be used to provide a list of groceries needed for a recipe. Grocery products may be associated with (known) source input placed at particular pre-identified locations (i.e., shelves) in the grocery store. The source input may be, for example, beacons, RFID signals, or Qyoos. Here a recipe may be used as the identified content to start with, and from the recipe the process may involve identifying individual ingredients. The individual ingredients are already associated with particular locations that can be provided on a map of the grocery store. The different locations can be shown together on a map, so that the user can find each ingredient in the list. In this example, using the grocery map, grocery list from the recipe, and information known about the user, the user device, and other database information, the user can be presented with coupons or other forms of advertising pertinent to the grocery store locations the user is being led to by the map. The content provided to the user can also be reflective of the user's previous grocery store purchases, purchases by similar users including other users who search for ingredients for the same recipe, and so on. Therefore, the user can be provided with relevant content determined based on expanded information known about the user beyond just the user's purchase history at the grocery store. The relevant content can be identified from other external applications such as social networking applications and recipe applications.

In accordance with an aspect of the present disclosure, a media processing system for providing services for metadata-seeking behavior, includes a memory that stores executable instructions; a processor that executes the executable instructions, and a receiver that receives, based on a person initiating capture of source input in seeking metadata for an object associated with the source input, source input from a requesting device used by the person to initiate the capture of the source input in the metadata-seeking behavior. When executed by the processor, the instructions cause the system to perform operations including identifying, based on the capture of the source input, metadata that is descriptive of the object associated with the source input and metadata descriptive of the person. The operations also include identifying, from the metadata identified, a set of historical data descriptive of a history of the person initiating the capture of the source input, and comparing, in a database, the set of historical data to historical data descriptive of histories of other persons for correlations that will identify content to present to the person initiating the capture of the source input. The operations moreover include dynamically identifying content based on the comparing, and sending the content dynamically identified for presentation to the person initiating the capture of the source input.

In accordance with another aspect of the present disclosure, the media processing system also identifies based on the capture of the source input, the capture of the source input.

In accordance with yet another aspect of the present disclosure, the media processing system also identifies, based on the capture of the source input, the person initiating the capture of the source input.

In accordance with still another aspect of the present disclosure, the historical data includes location history of the requesting device.

In accordance with another aspect of the present disclosure, the historical data includes gender of the user of the requesting device.

In accordance with yet another aspect of the present disclosure, the historical data comprises device type of the requesting device.

In accordance with still another aspect of the present disclosure, the historical data comprises email addresses.

In accordance with another aspect of the present disclosure, the historical data comprises personal addresses.

In accordance with yet another aspect of the present disclosure, the content dynamically identified comprises image data.

In accordance with still another aspect of the present disclosure, the content dynamically identified comprises video data.

In accordance with another aspect of the present disclosure, the content dynamically identified comprises text data.

In accordance with yet another aspect of the present disclosure, the content dynamically identified comprises javascript object notation (json) data.

In accordance with still another aspect of the present disclosure, the content dynamically identified comprises uniform resource locator (URL) data.

In accordance with another aspect of the present disclosure, the metadata-seeking behavior is identified from activity in capturing radio frequency identification data, and the source input is from a Bluetooth low energy (BLE) trigger identification data.

In accordance with yet another aspect of the present disclosure, the metadata-seeking behavior is identified from activity in capturing an image, and the source input is based on the captured image.

In accordance with still another aspect of the present disclosure, the metadata-seeking activity is identified from activity in capturing a video feed, and the source input is based on the captured video feed.

In accordance with another aspect of the present disclosure, the metadata-seeking behavior is identified from activity in capturing radio frequency identification data, and the source input is from captured radio frequency identification data.

In accordance with yet another aspect of the present disclosure, the metadata-seeking behavior is identified from activity in capturing barcode data, and the source input is from captured barcode data.

In accordance with still another aspect of the present disclosure, the metadata-seeking behavior is identified from activity in capturing a qyoo, and the source input is from a captured qyoo.

In accordance with another aspect of the present disclosure, a method is provided for identifying metadata based on source input obtained from metadata-seeking behavior. The method includes receiving, based on a person initiating capture of source input in seeking metadata for an object associated with the source input, source input from a requesting device used by the person to initiate the capture the source input in the metadata-seeking behavior. The method also includes identifying, based on the capture of the source input, metadata that is descriptive of the object associated with the source input and metadata descriptive of the person. The method also includes identifying, from the metadata identified, a set of historical data descriptive of a history of the person initiating the capture of the source input, and comparing, in a database, the set of historical data to historical data descriptive of histories of other persons for correlations that will identify content to present to the person initiating the capture of the source input. Content is dynamically identified based on the comparing. The content dynamically identified for presentation is sent to the person initiating the capture of the source input.

As described herein, content can be sent to a user as a result of the capture of the source input in the metadata-seeking behavior. Content can be a discount coupon, a game upgrade, a recipe recommendation, a personalized game, or many other types of individualized items of content that can be tailored to a user of a mobile device.

Examples provided herein include use of barcodes, quick response codes, Qyoos, Microsoft tags, Radio frequency identification information and the like. However, other forms of active and passive behaviors used to obtain metadata may also be used as they are developed in the future.

As described in the beginning of this disclosure, metadata-seeking behavior is normally expected to result in the return of metadata that describes an associated object. However, as described above, additional metadata can be used to provide additional content, or revised content, or replacement content, or even a variety of content that is not necessarily expected or sought by the person engaging in the metadata-seeking behavior. The additional metadata can be metadata descriptive of the person, the device used by the person, metadata provided by a network carrier, a social network, a third-party and so on. The additional content can be advertisements, advice, suggestions, or even metadata of a type known to be useful to the person.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A media processing system for providing services for metadata-seeking behavior, comprising:
a memory that stores executable instructions;
a processor that executes the executable instructions; and
a receiver that receives, based on a person initiating capture of source input in seeking metadata for an object associated with the source input, source input from a requesting device used by the person to initiate the capture of the source input in the metadata-seeking behavior,
wherein, when executed by the processor, the instructions cause the system to perform operations comprising:
identifying, based on receiving the source input, metadata that is descriptive of the object associated with the source input and metadata descriptive of the person;
identifying, from the metadata identified, a set of historical data descriptive of a history of the person;
comparing, in a database, the set of historical data to historical data descriptive of histories of other persons for correlations that will identify content to present to the person
dynamically identifying content based on the comparing, and
sending the content dynamically identified for presentation to the person.

2. The media processing system of claim 1,
wherein the operations further include identifying, based on the capture of the source input, the capture of the source input.

3. The media processing system of claim 1,
wherein the operations further include identifying, based on the capture of the source input, the person.

4. The media processing system of claim 1,
wherein the historical data comprises location history of the requesting device.

5. The media processing system of claim 1,
wherein the historical data comprises gender of the person.

6. The media processing system of claim 1,
wherein the metadata received further describes a device type of the requesting device.

7. The media processing system of claim 1,
wherein the historical data comprises email addresses.

8. The media processing system of claim 1,
wherein the historical data comprises personal addresses.

9. The media processing system of claim 1,
wherein the content dynamically identified comprises image data.

10. The media processing system of claim 1,
wherein the content dynamically identified comprises video data.

11. The media processing system of claim 1,
wherein the content dynamically identified comprises text data.

12. The media processing system of claim 1,
wherein the content dynamically identified comprises javascript object notation data.

13. The media processing system of claim 1,
wherein the content dynamically identified comprises uniform resource locator (URL) data.

14. The media processing system of claim 1,
wherein the metadata-seeking behavior is identified from activity in capturing radio frequency identification data, and the source input is from a Bluetooth low energy (BLE) trigger identification data.

15. The media processing system of claim 1,
wherein the metadata-seeking behavior is identified from activity in capturing an image, and the source input is based on the captured image.

16. The media processing system of claim 1
wherein the metadata-seeking activity is identified from activity in capturing a video feed, and the source input is based on the captured video feed.

17. The media processing system of claim 1,
wherein the metadata-seeking behavior is identified from activity in capturing radio frequency identification data, and the source input is from captured radio frequency identification data.

18. The media processing system of claim 1,
wherein the metadata-seeking behavior is identified from activity in capturing barcode data, and the source input is from captured barcode data.

19. The media processing system of claim 1,
wherein the metadata-seeking behavior is identified from activity in capturing a qyoo, and the source input is from a captured qyoo.

20. A method for identifying metadata based on source input obtained from metadata-seeking behavior, comprising:
receiving, based on a person initiating capture of source input in seeking metadata for an object associated with the source input, source input from a requesting device used by the person to initiate the capture the source input in the metadata-seeking behavior,
identifying, based on receiving the source input, metadata that is descriptive of the object associated with the source input and metadata descriptive of the person;
identifying, from the metadata identified, a set of historical data descriptive of a history of the person;
comparing, in a database, the set of historical data to historical data descriptive of histories of other persons for correlations that will identify content to present to the person;
dynamically identifying content based on the comparing, and
sending the content dynamically identified for presentation to the person.
